(19) United States
(12) Patent Application Publication
(10) Pub. No.: US 2021/0347922 A1
(43) Pub. Date: Nov. 11, 2021

(54) FLUOROCOPOLYMERS FOR COATING APPLICATIONS

(71) Applicant: HONEYWELL INTERNATIONAL INC., Charlotte, NJ (US)

(72) Inventors: Yan XU, Charlotte, NC (US); Jian HOU, Charlotte, NC (US)

(21) Appl. No.: 17/277,963

(22) PCT Filed: Sep. 20, 2018
(86) PCT No.: PCT/CN2018/106673

§ 371 Date: Mar. 19, 2021

(51) Int. Cl. C08F 214/24; C08F 216/14; C08F 214/18; C09D 129/10; C09D 127/12

(52) U.S. Cl. CPC C08F 214/247; C08F 216/1416; C08F 2800/20; C09D 129/10; C09D 127/12; C08F 214/188

(57) ABSTRACT

Disclosed are copolymers formed by copolymerization of: (1) haloolefin monomers consisting essentially of: (a) hydrofluorolefin selected from the group consisting of hydrofluoroethylenes, hydrofluoropropenes, hydrofluorobutenes, hydrofluoropentenes and combinations of these, and (b) one or more chlorofluoroethylene monomers wherein the mole ratio of said hydrofluoroolefin monomer to said chlorofluoroethylene monomers monomer is from about 0.5:1 to about 1.5:1; and (2) alkyl vinyl ether monomer(s) and/or alkyl vinyl ester monomers consisting essentially of: (a) one or more lower alkyl vinyl ether monomers that are not substituted with a reactive group; and (b) one or more reactive group substituted lower alkyl vinyl ether monomer(s) and/or one or more reactive group substituted, lower alkyl vinyl ester monomer(s), wherein the mole ratio of (2)(a) monomers to said (2)(b) monomers is from about 2:1 to about 6:1.

### FIELD OF THE INVENTION

The present invention relates to novel fluorocopolymers having a difficult to achieve combination of important properties, including excellent adhesion to substrates (especially compared to copolymers formed from fluoroethylene/vinylether (commonly referred to as FEVE resins), high resistance to weathering/corrosion, good flexibility and mechanical properties and/or high gloss. The present invention also relates to coating compositions formed from such polymers having high solids content, and to methods of reducing the exposure of earth's atmosphere to volatile organic compounds (VOCs) while forming protective coatings on substrates.

### BACKGROUND OF THE INVENTION

It has been known to use compositions based on polyvinylidene fluoride (PVDF) in high performance coating applications. For example, U.S. Pat. Nos. 8,093,329 and 7,399,533 disclose PVDF polymer resins and indicates that such resins provide good solvent resistance, chemical resistance, weather resistance, heat stability, strength and resilience. These coatings are based on non-aqueous dispersions of solid PVDF particles in an organic solution of acrylic polymers. The patents indicate that after baking the coating above the PVDF melting temperature, a homogenous blend of PVDF and acrylic phase is formed, which is said to provide the coating with durability and other properties such as gloss, adhesion, solvent resistance, and weatherability. However, the patent indicates that the coatings are

PVDF solvent-base coatings (e.g. KYNAR 500®) have been

usually used on metal substrates. PVDF combined with acrylic polymer additive for use in water-based coatings which can be applied on variety of substrates such as metal or ceramic surfaces, and in the impregnation of textiles, glass, carbon or aramid fibers. Although this patent indicates that such coatings A large number of possible monomers are identified for use in fluoropolymer portion of the coating composition, imonVolatile organic compounds (VOCs) are volatile compounds of carbon that are subject to regulation by various government authorities, and for the purposes of the present invention the term is used consistent with proposed regulations established by the United States Environmental Protection Agency (EPA). More specifically, these proposed regulations establish that a compound of carbon is a VOC if it has a vapor pressure of less than about 0.1 millimeters of mercury at 20° C.

A variety of chemicals are within the definition of VOC, and some of these chemicals have short- and long-term adverse health effects when released into the atmosphere. Accordingly, many countries have regulations governing the release of such compounds into the earth's atmosphere. One relatively large source of release of such compounds into the environment has been from the solvents that are used in coating products such as, paints, varnishes, waxes, adhesives, inks and the like. Many cleaning, disinfecting, cosmetic, degreasing, and hobby products also contain VOCs as solvents or carriers. One method to reduce or eliminate the release of such compounds into the atmosphere is to capture and prevent release of the solvent as it evaporates from the coating composition. Such methods can involve, for example, the installation of a mechanism to capture the vapors and to process such vapors in an incinerator. However, as will be appreciated to those skilled in the art a substantial capital cost and/or processing cost is incurred as a result of such operations, and such operations can sometimes add detrimentally to the time required to complete such coating operations.

In order to reduce and control the VOC emission into the earth's atmosphere, more and more countries have started to regulate VOC emissions. Such regulations include in various countries charging a VOC tax upon release of such compounds. Accordingly, there are many incentives to reduce the release of VOCs into the atmosphere.

### SUMMARY OF THE INVENTION

The present invention provides fluorocopolymers formed by copolymerization of:
(1) haloolefin monomers consisting essentially of:
   (a) a hydrofluorolefin selected from the group consisting of hydrofluoroethylenes, hydrofluoropropenes, hydrofluorobutenes, hydrofluoropentenes and combinations of these, and preferably selected from 2,3,3,3-tetrafluoropropene, 1,3,3,3-tetrafluoropropene, with said 1,3,3,3-tetrafluoropropene preferably comprising, consisting essentially of or consisting of trans-1,3,3,3-tetrafluoropropene, and combinations of these, and
   (b) one or more chlorofluoroethylene monomers, preferably chlorotrifluoroethylene (“CTFE”) monomers, wherein the mole ratio of said hydrofluoroolefin monomer to said chlorofluoroethylene monomers monomer is preferably from about 0.5:1 to about 1.5:1; and
(2) alkyl vinyl ether monomer(s) and/or alkyl vinyl ester monomers consisting essentially of:
   (a) one or more lower alkyl vinyl ether monomers that are not substituted with a reactive group; and
   (b) one or more reactive group substituted, preferably hydroxyl substituted, lower alkyl vinyl ether monomer(s) and/or one or more reactive group substituted, preferably hydroxyl substituted, lower alkyl vinyl ester monomer(s), wherein the mole ratio of (2)(a) monomers to said (2)(b) monomers is preferably from about 2:1 to about 6:1, and
(3) optionally one or more alkyl vinyl ester monomers that do not contain a reactive group substituted thereon,
   wherein the mole ratio of said haloolefin monomers to said alkyl vinyl ether monomer(s) is preferably from about 0.5:1 to about 1.5:1. A fluorocopolymer made in accordance with this paragraph is referred to herein for convenience as Fluorocopolymer 1.

One aspect of the present invention provides fluorocopolymers formed by copolymerization of:
(1) haloolefin monomers consisting essentially of:
   (a) hydrofluorolefin monomer(s) selected from the group consisting of hydrofluoroethylenes, hydrofluoropropenes, hydrofluorobutenes, hydrofluoropentenes and combinations of these, and preferably selected from 2,3,3,3-tetrafluoropropene, 1,3,3,3-tetrafluoropropene, with said 1,3,3,3-tetrafluoropropene preferably comprising, consisting essentially of or consisting of trans-1,3,3,3-tetrafluoropropene, and combinations of these, and
   (b) one or more chlorofluoroethylene monomers, preferably chlorotrifluoroethylene (“CTFE”) monomers, wherein the mole ratio of said hydrofluoroolefin monomer to said chlorofluoroethylene monomers monomer is preferably from about 0.8:1 to about 1.2:1; and
(2) alkyl vinyl ether monomer(s) consisting essentially of:
   (a) one or more alkyl vinyl ether monomers (where alkyl as used herein refers to any aliphatic or aromatic straight or branched chain having from about 6 to about 12 carbon atoms), that are not substituted with a reactive group; and
   (b) one or more reactive group substituted, preferably hydroxyl substituted, lower alkyl vinyl ether monomer(s), wherein the mole ratio of (2)(a) monomers to said (2)(b) monomers is preferably from about 2:1 to about 6:1, and
(3) optionally one or more alkyl vinyl ester monomers, wherein the mole ratio of said haloolefin monomers to said alkyl vinyl ether monomer(s) is preferably from about 0.5:1 to about 1.5:1. A fluorocopolymer made in accordance with this paragraph is referred to herein for convenience as Fluorocopolymer 2.

One aspect of the present invention provides fluorocopolymers formed by copolymerization of:
(1) haloolefin monomers consisting essentially of:
   (a) trans-1,3,3,3-tetrafluoropropene monomer; and
   (b) one or more chlorofluoroethylene monomers, preferably chlorotrifluoroethylene (“CTFE”) monomers, wherein the mole ratio of said trans-1,3,3,3-tetrafluoropropene monomer to said one or more chlorofluoroethylene monomers is preferably from about 0.5:1 to about 1.5:1; and
(2) alkyl vinyl ether monomer(s) consisting essentially of:
   (a) one or more lower alkyl vinyl ether monomers that are not substituted with a reactive group; and
   (b) one or more reactive group substituted, preferably hydroxyl substituted, lower alkyl vinyl ether monomer(s), wherein the mole ratio of (2)(a) monomers to said (2)(b) monomers is preferably from about 3:1 to about 5:1,
(3) optionally one or more alkyl vinyl ester monomers,
   wherein the mole ratio of said haloolefin monomers to said alkyl vinyl ether monomer(s) is preferably from about 0.8:1 to about 1.2:1. A fluorocopolymer made in accordance with this paragraph is referred to herein for convenience as Fluorocopolymer 3.

The present invention incudes Fluorocopolymer 1 having a number average molecular weight of greater from about 30,000 to about 40,000.

The present invention incudes Fluorocopolymer 1 having a number average molecular weight of greater from about 33,000 to about 38,000.

The present invention incudes Fluorocopolymer 2 having a number average molecular weight of greater from about 30,000 to about 40,000.

The present invention incudes Fluorocopolymer 2 having a number average molecular weight of greater from about 33,000 to about 38,000.

The present invention incudes Fluorocopolymer 3 having a number average molecular weight of greater from about 30,000 to about 40,000.

The present invention incudes Fluorocopolymer 3 having a number average molecular weight of greater from about 33,000 to about 38,000.

The present invention incudes Fluorocopolymer 1 having a number average molecular weight of greater from about 30,000 to about 40,000 and a hydroxyl value of from about 50 to about 300.

The present invention incudes Fluorocopolymer 1 having a number average molecular weight of greater from about 33,000 to about 38,000 and a hydroxyl value of from about 50 to about 300.

The present invention incudes Fluorocopolymer 2 having a number average molecular weight of greater from about 30,000 to about 40,000 and a hydroxyl value of from about 50 to about 300.

The present invention incudes Fluorocopolymer 2 having a number average molecular weight of greater from about 33,000 to about 38,000 and a hydroxyl value of from about 50 to about 300.

The present invention incudes Fluorocopolymer 3 having a number average molecular weight of greater from about 30,000 to about 40,000 and a hydroxyl value of from about 50 to about 300.

The present invention incudes Fluorocopolymer 3 having a number average molecular weight of greater from about 33,000 to about 38,000 and a hydroxyl value of from about 50 to about 300.

The present invention incudes Fluorocopolymer 1 having a number average molecular weight of greater from about 30,000 to about 40,000 and a hydroxyl value of from about 75 to about 100.

The present invention incudes Fluorocopolymer 1 having a number average molecular weight of greater from about 33,000 to about 38,000 and a hydroxyl value of from about 75 to about 100.

The present invention incudes Fluorocopolymer 2 having a number average molecular weight of greater from about 30,000 to about 40,000 and a hydroxyl value of from about 75 to about 100.

The present invention incudes Fluorocopolymer 2 having a number average molecular weight of greater from about 33,000 to about 38,000 and a hydroxyl value of from about 75 to about 100.

The present invention incudes Fluorocopolymer 3 having a number average molecular weight of greater from about 30,000 to about 40,000 and a hydroxyl value of from about 75 to about 100.

The present invention incudes Fluorocopolymer 3 having a number average molecular weight of greater from about 33,000 to about 38,000 and a hydroxyl value of from about 75 to about 100.

As used herein, the term “copolymer” means polymers having two or more different repeating units, and the term “fluorocopolymer” means copolymers in which at least one of the repeating units is based on a monomer that is a hydrofluoroolefin. The term “terpolymer” means polymers having three or more different repeating units, and the term “terfluorocopolymer” means terpolymers in which at least one of the repeating units is based on a monomer that is a hydrofluoroolefin. The term “tetrapolymer” is intended to include oligomers and copolymers having four or more different repeating units, and the term “tetrafluorocopolymer” means tetrapolymers in which at least one of the repeating units is based on a monomer that is a hydrofluoroolefin. Thus, a tetrapolymer derived from monomers A, B, C and D has repeating units (-A-), (-B-), (-C-) and (-D-), and a tetrafluorocopolymer derived from monomers A, B, C and D wherein at least one of these is a hydrofluoroolefin.

As used herein, the term “lower alkyl vinyl ether” refers to compounds having the following structure:

R—O—C═CH₂,
where R is a alkyl group having from 1 to 6 carbon atoms.

As used s used herein, the term “reactive group lower alkyl vinyl ether” refers to compounds having the following structure:

Rs-O—C═CH2,
where Rs is a alkyl group having from 1 to 6 carbon atoms having at least one reactive group substituent selected from hydroxyl groups, carboxyl groups and epoxy groups.

The repeating units according to the present invention can be arranged in any form, including as alternating copolymers, as periodic copolymers, statistical copolymers, block copolymers and graft copolymers.

According to certain preferred embodiments, the present invention provides terfluorocopolymers, and preferably tetrafluorcopolymers, formed by copolymerization of a mixture containing a combination of monomers, said monomer combination consisting essentially of:
(1) haloolefin monomers consisting essentially of:
   (a) trans-1,3,3,3-tetrafluoropropene monomer; and
   (b) one or more chlorofluoroethylene monomers, preferably chlorotrifluoroethylene (“CTFE”) monomers, wherein the mole ratio of said trans-1,3,3,3-tetrafluoropropene monomer to said one or more chlorofluoroethylene monomers is preferably from about 0.8:1 to about 1.2:1; and
   (2) alkyl vinyl ether monomer(s) consisting essentially of:
      (a) one or more lower alkyl vinyl ether monomers that are not substituted with a reactive group; and
      (b) one or more reactive group substituted, preferably hydroxyl substituted, lower alkyl vinyl ether monomer(s), wherein the mole ratio of (2)(a) monomers to said (2)(b) monomers is preferably from about 3:1 to about 5:1,
   (3) optionally one or more alkyl vinyl ester monomers,
      wherein the mole ratio of said haloolefin monomers to said alkyl vinyl ether monomer(s) is preferably from about 0.8:1 to about 1.2:1 and wherein said terfluorocopolymer has a number average molecular weight of from about 25,000 to about 40,000 and a hydroxyl value of from about 50 to about 300.

According to preferred aspects, the present invention provides tetrafluorocopolymers as described in the previous paragraph wherein the polymer has a number average molecular weight of greater from about 30,000 to about 40,000, more preferably about 33,000 to about 38,000, and preferably in other embodiments of about 35,000.

According to preferred aspects, the present invention provides tetrafluorocopolymers as described in the previous paragraph wherein the polymer has an Mn/Mw of from about 1.5 to about 5, more preferably about 2 to about 3, and preferably about 2.5.

According to preferred aspects, the present invention provides tetrafluorocopolymers as described in the previous paragraph wherein the polymer has a hydroxyl value of number average molecular weight of greater from about 50 to about 300 mgKOH/g, more preferably about 50 to about 100, and preferably from about 75 to about 100.

One aspect of the present invention provides methods of coating a a substrate with a protective coating comprising:
(a) providing a substrate, preferably a substrate comprising metal, to be coated;
(b) providing a coating composition which is formed by steps comprising:
   (i) providing one or more fluorocopolymers by copolymerization of:
      (1) fluoroolefin monomers consisting essentially of:
         (a) trans-1,3,3,3-tetrafluoropropene monomer; and
         (b) one or more chlorofluoroethylene monomers, preferably chlorotrifluoroethylene (“CTFE”) monomers, wherein the mole ratio of said trans-1,3,3,3-tetrafluoropropene monomer to said one or more chlorofluoroethylene monomers is preferably from about 0.8:1 to about 1.2:1; and
      (2) alkyl vinyl ether monomer(s) consisting essentially of:
         (a) one or more lower alkyl vinyl ether monomers that are not substituted with a reactive group; and
         (b) one or more reactive group substituted, preferably hydroxyl substituted, lower alkyl vinyl ether monomer(s), wherein the mole ratio of (2)(a) monomers to said (2)(b) monomers is preferably from about 3 to about 5,
            wherein the mole ratio of said haloolefin monomers to said alkyl vinyl ether monomer(s) is preferably from about 0.8:1 to about 1.2:1; and
(ii) providing a carrier for said one or more fluorocopolymers; and
(iii) combining said one or more fluorocopolymers with said carrier to produce a polymeric composition comprising not greater than about 50% by weight of said carrier, preferably with a solids content of at least about 50% by weight;
(c) coating the substrate with said coating composition; and
(d) forming a protective polymeric layer on said substrate by allowing at least a substantial portion of said carrier to evaporate, whereby said protective coating is formed.

The present invention provides methods of coating a substrate with a protective coating comprising:
(a) providing a substrate, preferably a substrate comprising metal, to be coated;
(b) providing a coating composition which is formed by steps comprising:
   (i) providing a fluorocopolymers according to Fluorocopolymer 1;
   (ii) providing a carrier for said one or more fluorocopolymers; and
   (iii) combining said fluorocopolymers with said carrier to produce a polymeric composition comprising not greater than about 50% by weight of said carrier, preferably with a solids content of at least about 50% by weight;
(c) coating the substrate with said coating composition; and
(d) forming a protective polymeric layer on said substrate by allowing at least a substantial portion of said carrier to evaporate, whereby said protective coating is formed.

The present invention provides methods of coating a substrate with a protective coating comprising:
(a) providing a substrate, preferably a substrate comprising metal, to be coated;
(b) providing a coating composition which is formed by steps comprising:
   (i) providing a fluorocopolymers according to Fluorocopolymer 2;
   (ii) providing a carrier for said one or more fluorocopolymers; and
   (iii) combining said fluorocopolymers with said carrier to produce a polymeric composition comprising not greater than about 50% by weight of said carrier, preferably with a solids content of at least about 50% by weight;
(c) coating the substrate with said coating composition; and
(d) forming a protective polymeric layer on said substrate by allowing at least a substantial portion of said carrier to evaporate, whereby said protective coating is formed.

The present invention provides methods of coating a substrate with a protective coating comprising:
(a) providing a substrate, preferably a substrate comprising metal, to be coated;
(b) providing a coating composition which is formed by steps comprising:
   (i) providing a fluorocopolymers according to Fluorocopolymer 3;
   (ii) providing a carrier for said one or more fluorocopolymers; and
   (iii) combining said fluorocopolymers with said carrier to produce a polymeric composition comprising not greater than about 50% by weight of said carrier, preferably with a solids content of at least about 50% by weight;
(c) coating the substrate with said coating composition; and
(d) forming a protective polymeric layer on said substrate by allowing at least a substantial portion of said carrier to evaporate, whereby said protective coating is formed.

One aspect of the present invention provides methods of coating a a substrate with a high gloss protective coating comprising:
(a) providing a substrate, preferably a substrate comprising metal, to be coated;
(b) providing a coating composition which is formed by steps comprising:
   (i) providing one or more fluorocopolymers by copolymerization of:
      (1) fluoroolefin monomers consisting essentially of:
         (a) trans-1,3,3,3-tetrafluoropropene monomer; and
         (b) one or more chlorofluoroethylene monomers, preferably chlorotrifluoroethylene (“CTFE”) monomers, wherein the mole ratio of said trans-1,3,3,3-tetrafluoropropene monomer to said one or more chlorofluoroethylene monomers is preferably from about 0.8:1 to about 1.2:1; and
      (2) alkyl vinyl ether monomer(s) consisting essentially of:
         (a) one or more lower alkyl vinyl ether monomers that are not substituted with a reactive group; and
         (b) one or more reactive group substituted, preferably hydroxyl substituted, lower alkyl vinyl ether monomer(s), wherein the mole ratio of (2)(a) monomers to said (2)(b) monomers is preferably from about 3 to about 5,
            wherein the mole ratio of said haloolefin monomers to said alkyl vinyl ether monomer(s) is preferably from about 0.8:1 to about 1.2:1; and
(ii) providing a carrier for said one or more fluorocopolymers; and
(iii) combining said one or more fluorocopolymers with said carrier to produce a polymeric composition comprising not greater than about 50% by weight of said carrier, preferably with a solids content of at least about 50% by weight;
(c) coating the substrate with said coating composition; and
(d) forming a protective polymeric layer on said substrate by allowing at least a substantial portion of said carrier to evaporate, whereby a protective coating having a 60° gloss of at least about 55, more preferably at least about 60 and even more preferably at least about 70.

One aspect of the present invention provides methods of coating a substrate with a high gloss protective coating comprising:
(a) providing a substrate, preferably a substrate comprising metal, to be coated;
(b) providing a coating composition which is formed by steps comprising:
   (i) providing one or more fluorocopolymers by copolymerization of:
      (1) fluoroolefin monomers consisting essentially of:
         (a) trans-1,3,3,3-tetrafluoropropene monomer; and
         (b) one or more chlorofluoroethylene monomers, preferably chlorotrifluoroethylene (“CTFE”) monomers, wherein the mole ratio of said trans-1,3,3,3-tetrafluoropropene monomer to said one or more chlorofluoroethylene monomers is preferably from about 0.8:1 to about 1.2:1; and
      (2) alkyl vinyl ether monomer(s) consisting essentially of:
         (a) one or more lower alkyl vinyl ether monomers that are not substituted with a reactive group; and
         (b) one or more reactive group substituted, preferably hydroxyl substituted, lower alkyl vinyl ether monomer(s), wherein the mole ratio of (2)(a) monomers to said (2)(b) monomers is preferably from about 3 to about 5,
            wherein the mole ratio of said haloolefin monomers to said alkyl vinyl ether monomer(s) is preferably from about 0.8:1 to about 1.2:1; and
(ii) providing a carrier for said one or more fluorocopolymers; and
(iii) combining said one or more fluorocopolymers with said carrier to produce a polymeric composition comprising not greater than about 50% by weight of said carrier, preferably with a solids content of at least about 50% by weight;
(c) coating the substrate with said coating composition; and
(d) forming a protective polymeric layer on said substrate by allowing at least a substantial portion of said carrier to evaporate, whereby a protective coating having a 60° gloss of at least about 55, more preferably at least about 60 and even more preferably at least about 70, and a gloss retention of at least about 90%, more preferably at least about 95%, preferably of at least about 99% after 3000 hours.

In preferred embodiments, the fluoropolymer of step (b) is formed by solution copolymerization, emulsion copolymerization and/or dispersion copolymerization of the fluoroolefin and alkyl vinyl ether monomers required by the providing step (b) in either the previous paragraphs. In preferred embodiments, the step of copolymerizing comprises solution copolymerizing:
(1) from about 40 mol % to about 70 mol %, and even more preferably from about 45 mol % to about 55 mol %, and even more preferably about 50 mol % of haloolefin monomer(s), preferably a combination of transHFO1234ze and CTFE; and
(2) from about 30 mol % to 60 mol % of alkyl vinyl ether monomers, more preferably from about 45 mol % to about 50 mol %, and even more preferably from about 50 mol % to about 40 mol %, preferably a combination of EVE and HBVE, with said percentages being based on the total monomers charged to solution copolymerization reaction vessel.

According to a preferred embodiments of the present invention, the co-polymer of the present invention is formed by copolymerization in a reaction medium a combination of monomers consisting essentially of:
(1) transHFO-1234ze in an amount of from about 20 mol % to about 50 mol %, and more preferably from about 20 to about 35 mol %,
(2) second monomer comprising CTFE, preferably in an amount of from about 15 mol % to about 35 mol %, and more preferably from about 20 mol % to about 30 mol %, wherein the mole ratio of monomer (1) to monomer (2) is preferably from about 0.75:1 to about 1.5:1, more preferably from about 0.8:1 to about 1.2:1;
(3) from about 10 mol % to about 50 mol % of vinyl ether, more preferably from about 30 mol % to about 50 mol %, more preferably from about 35 mol % to about 45 mol %, represented by formula CH₂═CR³—OR⁴ respectively, wherein R³ is independently either hydrogen or a methyl group and wherein R⁴ is independently selected from the group consisting of a substituted or unsubstituted straight-chain or branched-chain alkyl group having 1 to 5 carbon atoms; and
(4) hydroxyl group-containing vinyl ether monomer(s), preferably in an amount of from about 5 mol % to about 35 mol % of hydroxy vinyl ether monomer, preferably in an amount of from about 5 mol % to about 30 mol %, more preferably from about 5 mol % to about 20 mol %, and even more preferably from about 5 mol % to about 15 mol %, represented by formula CH₂═C—R⁵—OH, where R⁵ is selected from the group consisting of a C2 to C10 substituted or unsubstituted straight-chain or branched-chain alkyl group, wherein the mol % are based on the total of the monomers in the copolymer formation step.

As used herein, unless otherwise specifically indicated, reference to mol % is to the mol % of monomers used in the formation of the fluorocopolymer of the present invention, based on the total of the monomers.

In certain embodiments of the process, the copolymer formed by step (b) of the present invention has a number average molecular weight as measured by gel phase chromatography (“GPC”) according to the method described in Skoog, D. A. Principles of Instrumental Analysis, 6th ed.; Thompson Brooks/Cole: Belmont, Calif., 2006, Chapter 28, which is incorporated herein by reference, of from about 20000 and 50,000, more preferably from about 25,000 to about 40,000, more preferably from about 30,000 to about 40,000 and in certain embodiments a Mw/Mn of from weight average molecular weight preferably from about 2 to about 5, and more preferably from about 3 to about 4. The values described herein for molecular weight are based on measurements that use an Agilent-PL gel chromatography column (5 um MIXED-C 300*7.5 mm). The mobile phase is tetrahydrofuran (THF) at a flow rate of 1 ml/minute and a temperature of 35° C. A refractive index detector is used. The unit is calibrated with polystyrene narrow standard available from Agilent.

As used herein, the term “substrate” refers to any device or article, or part of a device or article, to be coated.

As used herein, the term “carrier” is intended to refer to a component of a composition that serves to solvate, disperse and/or emulsify a monomeric or polymeric component of a composition.

### DETAILED DESCRIPTION OF THE INVENTION

As described above, preferred aspects of the present invention involve coating methods that provide effective, efficient and high gloss protective coatings on substrates. As those skilled in the art will appreciate, the quality of a protective coating applied to a substrate can be measured by a variety of coating properties that, depending on the particular application, are important for achieving a commercially successful coating on a given substrate. These properties include but are not limited to: (1) viscosity, (2) color retention; (3) gloss; (4) flexibility; (5) gloss retention; and (5) substrate adhesion.

In preferred embodiments, the fluorcopolymers of the present invention have a hydroxyl value of greater than about 50, and in other preferred embodiments have a hydroxyl value of from about 60 to about 90. As mentioned above, the ability to achieve such a method resides, in part, on the judicious selection of the type and the amounts of the various components that are used to form the fluoropolymer and the coating compositions of the present invention.

In preferred embodiments, the polymers of the present invention have a fluorine content of from about 30% to about 40% by weight and a chlorine content of from about 5% to about 15% by weight. In other preferred embodiments, the polymers of the present invention have fluorine content of from about 30% to about 35% by weight and a chlorine content of from about 9% to about 15% by weight.

Monomers

Hydrofluoroolefins

The hydrofluoroolefin monomers according to the methods of the present invention can include in certain preferred embodiments hydrofluoroethylene monomer, that is, compounds having the formula CX¹X²═CX³X⁴; wherein X′, X², X³, X⁴ are each independently selected from H or F or Cl atom, but at least one of them is a hydrogen atom. Examples of hydrofluoroethylene monomers include, among others:

CH₂═CHF,

CHF═CHF,

CH₂═CF₂, and

CHF═CF₂.

The hydrofluoroolefin monomers according to certain preferred aspects of the methods of the present invention include, and preferably consists essentially of or consist of hydrofluoropropenes having the formula CX⁵X⁶═CX⁷CX⁸X⁹X¹⁰; wherein X⁵, X⁶, X⁷, X⁸, X⁹ and X¹⁰ are independently selected from H or F or Cl atom, but at least one of them is a hydrogen atom and another is a fluorine atom. Examples of hydrofluoro-propene monomers include, among others:

CH₂═CFCF₃(HFO-1234yf),

trans-CHF═CHCF₃(trans-HFO-1234ze),

CHCl═CFCF₃ and

CH₂═CHCF₃.

In preferred embodiments, the hydrofluoroolefin comprises, consists essentially of or consist of HFO-1234yf and/or HFO-1234ze. In preferred embodiments, the hydrofluoroolefin comprises, consists essentially of or consist of HFO-1234ze, with said HFO-1234ze preferably comprising, consisting essentially of or consisting of trans-HFO-1234ze.

The hydrofluoroolefin monomers according to certain preferred aspects of the methods of the present invention include, hydrofluorobutene according to the following formula: CX¹¹X¹²═CX¹³CX¹⁴X¹⁵CX¹⁶X¹⁷X¹⁸; wherein X¹¹, X¹², X¹³, X¹⁴, X¹⁵, X¹⁶, X¹⁷ and X¹⁸ are independently selected from H or F or Cl atom, but at least one of them is a hydrogen atom and at least one is a fluorine atom. Examples of hydrofluorobutene include, among others, CF₃CH═CHCF₃.

Vinyl Esters

The copolymers in accordance with the present invention preferably are also formed from vinyl ester monomer units, preferably in amounts when present of from about 5 mol % to about 45 mol %, more preferably from about 5 mol % to about 10 mol %. In preferred embodiments the vinyl ester monomer(s) are represented by the formula CH₂═CR¹—O(C═O)_{X}R², wherein x is 1 and wherein R¹ is either hydrogen or a methyl group, and wherein R² is selected from the group consisting of a substituted or unsubstituted, preferably unsubstituted, straight-chain or branched-chain, preferably branched chain, alkyl group having 5 to 12 carbon atoms, more preferably having from 5 to 10 carbon atoms, and even more preferably 8 to 10 carbon atoms. In preferred embodiments the alkyl group includes at least one tertiary or quaternary carbon atom. In highly preferred embodiments, the vinyl ester includes at least one quaternary carbon according to the following formula:

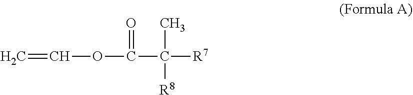

where each of R⁷ and R⁸ are alkyl groups, preferably branched alkyl groups, that together contain from 5 to about 8, more preferably from 6 to 7, carbon atoms.

Examples of vinyl ester monomers that are preferred according to certain preferred embodiments include vinyl acetate, vinyl propionate, vinyl butyrate, vinyl pivalate, vinyl capronate, vinyl laurate, VEOVA-9 (vinyl versatate ester formed from a C9 carbocylic acid, produced by Momentive), VEOVA-10 (vinyl versatate ester formed from a C10 carbocyclic acid, produced by Momentive) and vinyl cyclohexanecarboxylate. Each of VEOVA-9 and VEOVA-10 contain at least one quaternary carbon according to Formula A above. According to preferred embodiments, the vinyl ester comprises vinyl versatate ester having from 11 to 12 carbon atoms in the molecule, preferably with at least one quaternary carbon according to Formula A above.

Vinyl Ethers

The copolymers in accordance with the present invention preferably are also formed from vinyl ether monomer units, preferably in amounts of from about 5 mol % to about 45 mol %, more preferably from about 10 mol % to about 30 mol %, and even more preferably from about 10 mol % to about 20 mol %. In preferred embodiments the vinyl ester monomer(s) are represented by the formula CH₂═CR³—OR⁴, wherein R³ is independently either hydrogen or a methyl group and wherein R⁴ is selected from the group consisting of a substituted or unsubstituted, preferably unsubstituted, straight-chain or branched-chain, preferably straight chain, alkyl group having 1 to 5 carbon atoms, more preferably 1 to 3 carbon atoms. Examples of vinyl ether monomers that are preferred according to certain preferred embodiments include alkyl vinyl ethers such as methyl vinyl ether, ethyl, propyl vinyl ether, n-butyl vinyl ether, isobutyl vinyl ether, hexyl vinyl ether, octyl vinyl ether, decyl vinyl ether and lauryl vinyl ether. Vinyl ethers including an alicyclic group can also be used, for example, cyclobutyl vinyl ether, cyclopentyl vinyl ether and cyclohexyl vinyl ether. According to preferred embodiments the vinyl ether comprises, consists essentially of, or consists of ethyl vinyl ether.

Hydroxy Vinyl Ethers

The copolymers in accordance with the present invention preferably are also formed from hydroxyl vinyl ether monomer units, preferably in amounts of from about 5 mol % to about 40 mol % of hydroxy vinyl ether monomer, preferably in an amount of from about 8 mol % to about 35 mol %, more preferably from about 8 mol % to about 15 mol %. In preferred embodiments the hydroxyl vinyl ether monomer(s) are represented by the formula represented by formula CH₂═CR³—O—R⁵—OH, where R³ is as defined above, preferably hydrogen, and where R⁵ is selected from the group consisting of a C2 to C6 substituted or unsubstituted, preferably unsubstituted, straight-chain or branched-chain, preferably straight chain, alkyl group. Examples of preferred hydroxyalkyl vinyl ether monomers include hydroxyl-ethyl vinyl ether, hydroxypropyl vinyl ether, hydroxybutyl vinyl ether, hydroxypentyl vinyl ether and hydroxyhexyl vinyl ether. In certain embodiments, the copolymer is formed from about 5 mol % to about 20 mol % of hydroxyalkyl vinyl ether monomers, based on the total weight of the monomer.

In preferred embodiments, the co-monomers according to the fluorocopolymer formation step comprise, and preferably consist essentially of:
(1) first monomer consisting essentially of HFO-1234ze, preferably in an amount of from about 20 mol % to about 50 mol %, and even more preferably from about 20 mol % to about 40 mol %, and even more preferably about 25 mol %,
(1) second monomer consisting essentially of CTFE, preferably in an amount of from about 20 mol % to about 30 mol %, and even more preferably from about 22 mol % to about 27 mol %, and even more preferably about 25 mol %,
(3) vinyl ether monomer(s), represented by formula CH₂═CR³—OR⁴ respectively, wherein R³ is independently either hydrogen or a methyl group, preferably hydrogen, and wherein R⁴ is selected from the group consisting of a substituted or unsubstituted straight-chain or branched-chain, preferably straight chain, alkyl group having 1 to 3 carbon atoms, preferably 2 carbon atoms, said vinyl ether monomer(s) preferably being present in amounts of from about 15 mol % to about 45 mol %, more preferably from about 15 mol % to about 40 mol %, more preferably from about 10 mol % to about 30 mol %, and even more preferably from about 10 mol % to about 20 mol %; and
(4) hydroxyalkyl vinyl ether represented by formula CH₂═CR³—O—R⁵—OH, where R³ is methyl or hydrogen, preferably hydrogen, and R⁵ is selected from the group consisting a substituted or unsubstituted straight-chain or branched-chain C3 to C5 alkyl, preferably C4, unsubstituted straight-chain alkyl group, wherein the amount of said third monomer is preferably present in an amount of from about 5 mol % to about 25 mol %.

### CoPolymer Formation Methods

It will be appreciated by those skilled in the art, based on the teachings contained herein, that copolymers of the present invention may be formed to achieve the preferred characteristics described herein using a variety of techniques, and all such techniques are within the scope of the present invention.

In preferred embodiments, the fluorocopolymer is preferably produced in a polymerization system that utilizes a carrier for the monomer/polymer during and/or after formation. According to one preferred embodiment the carrier acts as a solvent and/or dispersant for the monomer and/or polymer, and such operations include dispersion, emulsion and solution polymerization. Examples of carriers in such systems, including preferably solvents for solution polymerization, include: esters, such as methyl acetate, ethyl acetate, propyl acetate and butyl acetate; ketones, such as acetone, methyl ethyl acetone and cyclohexanone; aliphatic hydrocarbons, such as hexane, cyclohexane, octane, nonane, decane, undecane, dodecane and mineral spirits; aromatic hydrocarbons, such as benzene, toluene, xylene, naphthalene, and solvent naphtha; alcohols, such as methanol, ethanol, tert-butanol, iso-propanol, ethylene glycol monoalkyl ethers; cyclic ethers, such as tetrahydrofuran, tetrahydropyran, and dioxane; fluorinated solvents, such as HCFC-225 and HCFC-141b; dimethyl sulfoxide; and the mixtures thereof.

It is contemplated that the temperature conditions used in the polymerization process of the present invention can be varied according to the particular equipment and applications involved and all such temperatures are within the scope of the present invention. Preferably, the polymerization is conducted at a temperature in a range of from about 30° C. to about 150° C., more preferably from about 40° C. to about 100° C., and even more preferably from about 50° C. to about 70° C., depending on factors such as the polymerization initiation source and type of the polymerization medium.

In certain preferred embodiments, it is preferred that the solution polymerization is conducted under conditions under which the total amount of the solvent used in the copolymerization process, based on the weight of the solvent and monomer in the solution, is from about 10 wt % to about 40 wt %, more preferably in amounts of from about 20 wt % to about 40 wt %, and more preferably in certain embodiments in an amount of from about 20 wt % to about 35%. In certain of such embodiments, the solvent used in the solution copolymerization process comprises, preferably consists essentially of, and more preferably in certain embodiments consists of C2-C5 alkyl acetate, and even more preferably butyl acetate.

In preferred embodiments, the formation of fluorocopolymer coating compositions comprises, and preferably consists essentially of:
(i) providing one or more fluorocopolymers by copolymerization of
   (1) first monomer consisting essentially of HFO-1234ze, with said HFO-1234ze preferably comprising, consisting essentially of or consisting of trans-HFO-1234ze, preferably in an amount of from about 20 mol % to about 45 mol %, and even more preferably from about 25 mol % to about 40 mol %,
   (2) second monomer(s) consisting essentially of CTFE, preferably in an amount of from about 20 mol % to about 30 mol %,
   (3) third monomers comprising vinyl ether monomer(s), represented by formula CH₂═CR³—O—R⁴, wherein R³ is either hydrogen or a methyl group, preferably hydrogen, and wherein R⁴ is selected from the group consisting of a substituted or unsubstituted straight-chain or branched-chain, preferably straight chain, alkyl group having 1 to 3 carbon atoms, preferably 2 carbon atoms, said vinyl ether monomer(s) preferably being present in amounts of from about 10 mol % to about 45 mol %, more preferably from about 15 mol % to about 40 mol %; and
   (4) fourth monomer(s) consisting of hydroxyalkyl vinyl ether represented by the formula CH₂═CR³—O—R⁵—OH, where R³ is methyl or hydrogen, preferably hydrogen, and R⁵ is selected from the group consisting of a C3 to C5, preferably C4, unsubstituted straight-chain alkyl group, wherein the amount of said third monomer is preferably from about 5 mol % to about 35 mol %, more preferably 5 mol % to 25 mol %; and
(ii) providing a carrier for said one or more fluorocopolymers, said carrier preferably selected from aromatic hydrocarbons such as xylene and toluene; alcohols such as n-butanol; esters such as butyl acetate; ketones such as methyl isobutyl ketone, and glycol ethers such as ethyl cellosolve, with C2-C5 alkyl acetate being preferred, and even more preferably comprising, consisting essentially of, or consisting of butyl acetate; and
(iii) combining said one or more fluorocopolymers with said carrier to produce a polymeric composition comprising not greater than about 30% by weight of said carrier, preferably with a solids content of at least about 70% by weight.

According to preferred embodiments, the fluorocopolymer composition of the present invention, and in particular the fluorocopolymer formed as described in the preceding sentence, has a polymer number average molecular weight as measured. It is also preferred in such embodiments as described in the present application in general, and in this paragraph as in particular, that the coating compositions of the present invention have a viscosity at 25° C. of less than about 1900 mPa-s, more preferably less than about 1800 mPa-s and even more preferably of less than about 1700 mPa-s as measured by Ford Cup at least at one of 12 revolutions per minutes (r/m), 30 r/m and 60 r/m, and preferably at all three speeds, preferably as measured according to ASTM D1200-10(2014) or ASTM D2196 as appropriate.

According to preferred embodiments, the fluorocopolymer composition of the present invention, and in particular the fluorocopolymer formed as described in each of the preceding paragraphs, has a polymer number average molecular weight as measured by gel phase chromatography (“GPC”) according to the method described in Skoog, D. A. Principles of Instrumental Analysis, 6th ed.; Thompson Brooks/Cole: Belmont, Calif., 2006, Chapter 28, which is incorporated herein by reference, of from greater than about 20000.

### Coating Composition Formation Methods

The copolymers as formed in accordance with the procedures described herein may then be used to form various coating compositions that have the substantial advantages described above. For example, various solvents can be used for the preparation of solution-type paints or coatings by adding those solvents to the fluorocopolymer of the present invention formed as described herein. In certain embodiments, preferred solvents for formation of the coating composition include aromatic hydrocarbons such as xylene and toluene; alcohols such as n-butanol; esters such as butyl acetate; ketones such as methyl isobutyl ketone, and glycol ethers such as ethyl cellosolve and various commercial thinners.

In certain embodiments, the coating composition of the present invention has a solid content of from about 70% to about 90% by weight based on the total weight of the coating composition, and more preferably in certain embodiments from about 75% go about 85% by weight of solids. In certain preferred embodiments, the solids comprise and preferably consist essentially of the copolymers of the present invention and/or cross-linked copolymers formed using the copolymers of the present invention. Although it is contemplated that those skilled in the art will be able to form coatings using the present compositions according to anyone of known methods, in preferred embodiment the coating is formed by brushing, a rolling, air spraying, airless spraying, flow coating, roller coating, a spin coating, and the like and any combination of these may be used. Furthermore, the coating can be applied on various substrates. The coating film can be formed directly on a substrate or via a primer or if necessary, via an undercoating layer. Although all thicknesses are within the scope of the present invention, in preferred embodiments the outermost cured coating film layer has a layer thickness of from about 20 to about 30 μm.

### EXAMPLES

The present invention is further illustrated by the following non-limiting examples.

### Example 1—Fluoropolymer Preparation

A solution polymerization operation is carried out by charging into a 1 liter stainless steel autoclave equipped with a stirrer the components as indicated in the following Table 1 in accordance with the procedure descried thereafter:

TABLE 1

| | | | | Mono- | Mono- |
|---|---|---|---|---|---|
| COMPONENT | | Weight, | | mer | mer, |
| TYPE | NAME | grams | Wt % | Moles | mol % |
| Solvent | Xylene | 144 | | | |
| | Ethyl acetate | 54 | | | |
| Hydro- | trans-1,3,3,3- | 100 | | | |
| haloolefin | tetrafluoropropene | | | | |
| Monomer | (trans-HFO-1234ze) | | | | |
| | CTFE | 100 | | | |
| Alkyl vinyl | EVE | 42.1 | | | |
| ether | | | | | |
| monomer | | | | | |
| | HBVE | 132.3 | | | |
| Catalyst | Potassium carbonate | 5 | | | |
| | (K₂CO₃) | | | | |
| Initiator | tertbutylperoxypivalate | 4.8 | | | |

The K₂CO₃ was added to the autoclave, and then the autoclave vacuumed and sealed. The xylene, ethyl acetate, EVE and HBVE were then charged into the autoclave. Then, the trans-HFO-1234ze and CTFE were added in the reaction mixture in the autoclave, and the autoclave was gradually heated to about 55° C. with agitation of about 400 revolutions per minute (rpm). When the temperature in the reactor reached about 55° C., the tert-butyl peroxypivalate was added into the autoclave and allowed to react under these conditions for about 18 hours. After 18 hours, the temperature in the reactor was increased from about 55° C. to about 65° C., and the autoclave was maintained at this temperature of about 65° C. for 5 hours. The autoclave reactor was then cooled to room temperature, and the unreacted monomers were purged and the autoclave was opened. The contents of the autoclave was a copolymer solution having a solids content of about 47 weight percent. The final fluorocopolymer (without solvent) was tested and found to have: a number average molecular weight (Mn) of about 24,548 and a Mw/Mn of 3.92; a hydroxyl value of 229.7 mg KOH/g; a Fluorine content of 33.59% and a Chlorine content of 7.88%. The copolymer had a density (g/cc at 35C) of about 1.1. The yield of cofluoropolymer was about 75.6%.

The result reported in Example 1 above indicates that the fluorocopolymer according to the present invention is capable of forming formulations for protective coatings, and accordingly the present fluorocopolymer has excellent usefulness in the formation of protective coatings in conjunction with a wide variety of materials that may be used, for example, as supplemental carriers in such coating compositions.

### Example 2—Fluoropolymer Preparation

A solution polymerization operation is carried out by charging into a 1 liter stainless steel autoclave equipped with a stirrer the components as indicated in the following Table 2 in accordance with the procedure descried thereafter:

TABLE 2

| | | | | Mono- | Mono- |
|---|---|---|---|---|---|
| COMPONENT | | Weight, | | mer | mer, |
| TYPE | NAME | grams | Wt % | Moles | mol % |
| Solvent | Ethanol | 25 | | | |
| | butyl acetate | 225 | | | |
| Hydro- | trans-1,3,3,3- | 210 | | | |
| haloolefin | tetrafluoropropene | | | | |
| Monomer | (trans-HFO-1234ze) | | | | |
| | CTFE | 105 | | | |
| Alkyl vinyl | EVE | 88.8 | | | |
| ether | | | | | |
| monomer | | | | | |
| | HBVE | 52.3 | | | |
| Alkyl vinyl | Veova - 10 | 27.8 | | | |
| ether ester | | | | | |
| Catalyst | Potassium carbonate | 5 | | | |
| | (K₂CO₃) | | | | |
| Initiator | tertbutylperoxypivalate | 3.6 | | | |

The K₂CO₃ was added to the autoclave, and then the autoclave vacuumed and sealed. The ethanol, butyl acetate, EVE, Veova-10 and HBVE were then charged into the autoclave. Then, the trans-HFO-1234ze and CTFE were added in the reaction mixture in the autoclave, and the autoclave was gradually heated to about 55° C. with agitation of about 400 revolutions per minute (rpm). When the temperature in the reactor reached about 55° C., the tert-butyl peroxypivalate was added into the autoclave and allowed to react under these conditions for about 24 hours. After these 24 hours had elapsed, the temperature in the reactor was increased from about 55° C. to about 65° C., and the autoclave was maintained at this temperature of about 65° C. for 5 hours. The autoclave reactor was then cooled to room temperature, and the unreacted monomers were purged and the autoclave was opened. The contents of the autoclave was a copolymer solution having a solids content of about 44.6 weight percent. The final fluorocopolymer (without solvent) was tested and found to have: a number average molecular weight (Mn) of about 25,221 and a Mw/Mn of 3.54; a hydroxyl value of 96 mg KOH/g; a Fluorine content of 34.42% and a Chlorine content of 9.29%. The copolymer had a density (g/cc at 35C) of about 1.1. The yield of cofluoropolymer was about 88.7%.

The result reported in Example 2 above indicates that the fluorocopolymer according to the present invention is capable of forming formulations for protective coatings, and accordingly the present fluorocopolymer has excellent usefulness in the formation of protective coatings in conjunction with a wide variety of materials that may be used, for example, as supplemental carriers in such coating compositions.

### Example 3—Fluoropolymer Preparation

A solution polymerization operation is carried out by charging into a 1 liter stainless steel autoclave equipped with a stirrer the components as indicated in the following Table 3 in accordance with the procedure descried thereafter:

TABLE 3

| | | | | Mono- | Mono- |
|---|---|---|---|---|---|
| COMPONENT | | Weight, | | mer | mer, |
| TYPE | NAME | grams | Wt % | Moles | mol % |
| Solvent | Xylene | 144 | | | |
| | Ethyl acetate | 54 | | | |
| Hydro- | trans-1,3,3,3- | 100 | | | |
| haloolefin | tetrafluoropropene | | | | |
| Monomer | (trans-HFO-1234ze) | | | | |
| | CTFE | 100 | | | |
| Alkyl vinyl | EVA | 98.1 | | | |
| ether | | | | | |
| monomer | | | | | |
| | HBVE | 40.8 | | | |
| Catalyst | Zinc oxide (ZnO) | 15 | | | |
| Initiator | tertbutylperoxypivalate | 4.8 | | | |

The ZnO was added to the autoclave, and then the autoclave vacuumed and sealed. The xylene, ethyl acetate, EVE and HBVE were then charged into the autoclave. Then, the trans-HFO-1234ze and CTFE were added in the reaction mixture in the autoclave, and the autoclave was gradually heated to about 55° C. with agitation of about 400 revolutions per minute (rpm). When the temperature in the reactor reached about 55° C., the tert-butyl peroxypivalate was added into the autoclave and allowed to react under these conditions for about 6 hours. After these 6 hours had elapsed, the reactor was then allowed to cool to room temperature, and the unreacted monomers were purged and the autoclave was opened. The contents of the autoclave was a copolymer solution having a solids content of about 44.1 weight percent. The final fluorocopolymer (without solvent) was tested and found to have: a number average molecular weight (Mn) of about 32,476 and a Mw/Mn of 2.32; a hydroxyl value of 84 mg KOH/g; a Fluorine content of 33.22% and a Chlorine content of 11.89%. The copolymer had a density (g/cc at 35C) of about 1.1. The yield of cofluoropolymer was about 72.5%.

The result reported in Example 3 above indicates that the fluorocopolymer according to the present invention is capable of forming formulations for protective coatings, and accordingly the present fluorocopolymer has excellent usefulness in the formation of protective coatings in conjunction with a wide variety of materials that may be used, for example, as supplemental carriers in such coating compositions.

### Example 4—Fluoropolymer Preparation

A solution polymerization operation is carried out by charging into a 1 liter stainless steel autoclave equipped with a stirrer the components as indicated in the following Table 4 in accordance with the procedure descried thereafter:

TABLE 4

| | | | | Mono- | Mono- |
|---|---|---|---|---|---|
| COMPONENT | | Weight, | | mer | mer, |
| TYPE | NAME | grams | Wt % | Moles | mol % |
| Solvent | Xylene | 144 | | | |
| | Ethyl acetate | 54 | | | |
| Hydro- | trans-1,3,3,3- | 100 | | | |
| haloolefin | tetrafluoropropene | | | | |
| Monomer | (trans-HFO-1234ze) | | | | |
| | CTFE | 100 | | | |
| Alkyl vinyl | EVE | 98.0 | | | |
| ether | | | | | |
| monomer | | | | | |
| | HBVE | 40.2 | | | |
| Catalyst | Zinc oxide (ZnO) | 15 | | | |
| Initiator | tertbutylperoxypivalate | 4.8 | | | |
| Chain | Methanol | 20 | | | |
| transfer/ | | | | | |
| solvent | | | | | |

The ZnO was added to the autoclave, and then the autoclave vacuumed and sealed. The xylene, ethyl acetate, EVE, HBVE and methanol were then charged into the autoclave. Then, the trans-HFO-1234ze and CTFE were added in the reaction mixture in the autoclave, and the autoclave was gradually heated to about 55° C. with agitation of about 400 revolutions per minute (rpm). When the temperature in the reactor reached about 55° C., the tert-butyl peroxypivalate was added into the autoclave and allowed to react under these conditions for about 16 hours. After these 16 hours had elapsed, the reactor was then heated to 65° C. and maintained at about 65° C. for 6 hours. The reactor was then allowed to cool to room temperature, and the unreacted monomers were purged and the autoclave was opened. The contents of the autoclave was a copolymer solution having a solids content of about 44.1 weight percent. The final fluorocopolymer (without solvent) was tested and found to have: a number average molecular weight (Mn) of about 24395 and a Mw/Mn of 2.58; a hydroxyl value of 67 mg KOH/g; a Fluorine content of 35.0% and a Chlorine content of 10.0%. The copolymer had a density (g/cc at 35C) of about 1.1. The yield of cofluoropolymer was about 75.2%.

The result reported in Example 4 above indicates that the fluorocopolymer according to the present invention is capable of forming formulations for protective coatings, and accordingly the present fluorocopolymer has excellent usefulness in the formation of protective coatings in conjunction with a wide variety of materials that may be used, for example, as supplemental carriers in such coating compositions.

The result reported in Example 3 above indicates that the fluorocopolymer according to the present invention is capable of forming formulations for protective coatings, and accordingly the present fluorocopolymer has excellent usefulness in the formation of protective coatings in conjunction with a wide variety of materials that may be used, for example, as supplemental carriers in such coating compositions.

### Examples 5, 6 and 7—Coating Composition and Coating Properties

Three white paint samples were made using the fluorocopolymers of Examples 1, 2 and 3. In each case the white paste is formed by adding the amount of copolymer composition indicated in Table 5A below, and the other ingredients identified in Table 5A below in the amounts indicated, into a 500 ml can. 150 grams of glass beads are then added as grinding medium into the can and the contents are milled at 2500 rpm for 45 minutes or until the fines reaches 10 μm.

TABLE 5A
White Paste

| COMPONENT | | Parts by Weight | | |
|---|---|---|---|---|
| TYPE | NAME | 5A | 5B | 5C |
| Resin | Example 1 copolymer | 128 | | |
| | Example 2 copolymer | | 135 | |
| | Example 3 copolymer | | | 136 |
| Pigment | Titanium oxide | 60 | 60 | 60 |
| | (Ti-Pure R960) | | | |
| Solvent | Xylene | 6 | 2.5 | 2 |
| | Acetone | 6 | 2.5 | 2 |

The glass beads are removed from the white paste so produced, and then the white paste without the glass beads is introduced, together with curing agent and other additives, into a new can, and stirred at 1500 rpm for about 15 minutes or until a uniform solution is achieved. This pigment paste is combined with additional resin as indicated in Table 5B below to produce the Let Down (Main Package).

TABLE 5B
Let Down (Main Package)

| COMPONENT | | Parts by Weight | | |
|---|---|---|---|---|
| TYPE | NAME | LD5A | LD5B | LD5C |
| White Paste (as | 5A | 63.5 | | |
| per Table 5A) | | | | |
| | 5B | | 78 | |
| | 5C | | | 80 |
| Catalyst | Dibutyl TinDilaurate | 4.45 | 4.65 | 4.26 |
| | (DBTDL, 0.01 in Butyl | | | |
| | Acetate | | | |
| Crosslinker | Desmodur BL-3175² | 31.0 | 16 | 14.3 |
| UV Absorber | Tinuvin 1130³ | 0.35 | 0.45 | 0.48 |
| HALS | Tinuvin 292³ | 0.7 | 0.9 | 0.96 |
| Totals | | 100 | 100 | 100 |
| Solids (%) | | 61.55 | 59.4 | 59.18 |

²From Covestro (formerly Bayer MaterialScience)
³From BASF

The white paint samples identified as LD5A, LD5B and LD5C in Table 5B above were applied to over hot dipped galvanized steel (HDG). The thickness of the substrate was about 0.4 mm. The substrate was received with primer already applied—the primer was the commercial polyester primer and thickness was about 5 μm. Each coated sample was then placed in an oven set at a temperature of 305° C. and maintained in the oven for about 35 seconds, at which point the metal temperature reached about 232° C. Each sample was removed from the oven and then quenched in water and dried with a tissue. The dry thickness of the topcoat was about 15 μm. Properties of the coating were tested according to AAMA 2605, and for UV exposure, the following exposure program (in accordance with ASTM G 154, Cycle 3) was selected, and the results of this testing are provided in Tables 5C.

TABLE 5C

| | | | | Results | |
|---|---|---|---|---|---|
| Property | Test Method | | LD5A | LD5B | LD5C |
| Gloss | ASTM D 523 | 60° | 61.3 | 58.3 | 74.2 |
| Pencil | ASTM D 3363 | Gouge | HB | HB | HB |
| hardness | | | | | |
| Flexibility | ASTM D 4145 | T-bend | 2T/2T* | 1T/1T | 0T/1T |
| Dry adhesion | ASTM D 3359 | Cross- | 5B | 5B | 5B |
| | | hatch | | | |
| Wet adhesion | AAMA 2605 | 8.4.1.3 | 5B | 5B | 5B |
| | | 8.4.1.4 | 4B | 5B | 5B |

| | | | |
|---|---|---|---|
| Acid | AAMA 2605 | 8.7.1 | No blistering, |
| resistance | | | no color change |

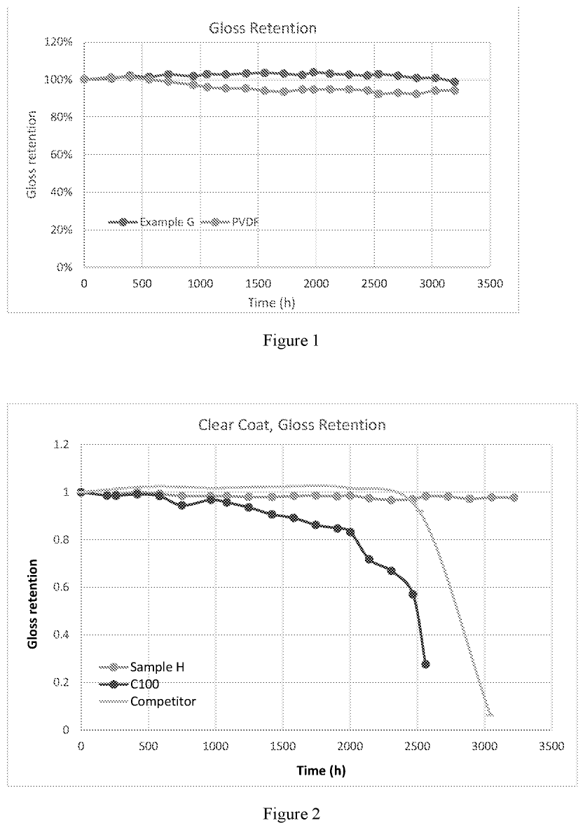

The samples are tested for UV exposure using a UVB-313 lamp with a typical irradiance of 0.49 W/m2/nm, and approximate wavelength of 310 nm, with an 8 hour UV at 70 (±3) ° C. Black Panel Temperature and 4 hour of condensation at 50 (±3) ° C. Black Panel Temperature. The results show for LD5C, which is representative of the results obtained with the other samples, are that gloss retention is initially about 100% and remains at or above 100% for 3000 hours of the test. This result is illustrated in FIG. 1 hereof, which also shows for comparison results using PVDF in the same test in which gloss retention values are significantly lower than the paint of the present invention after about 500 hours.

### Examples 8—Coating Composition and Coating Properties

A single component varnish (Clear Paint) is made using the copolymer from Example 4 above. All the ingredients identified in Table 6.

TABLE 6A

| Ingredient | Function | Parts By Weight |
|---|---|---|
| Example 4 Copolymer | Resin | 76.93 |
| Dibutyl TinDilaurate | Catalyst | 5 |
| (DBTDL, 0.01 in Butyl Acetate) | | |
| Desmodur BL-3175 | Crosslinker | 16.1 |
| Tinuvin 1130 | UV absorber | 1.31 |
| Tinuvin 292 | HALS | 0.66 |
| Total | | 100 |

The ingredients identified in Table 6A were added into a 200 ml can and then stirred at 1500 rpm for 5 min or until uniform. The material thus produced was applied to over hot dipped galvanized steel (HDG). The thickness of the substrate was about 0.4 mm. The substrate was received with 5 μm primer already applied—the primer had a was the commercial polyester primer and thickness was about 5 μm and a layer of 15 μm PVDF coating over the primer. The sample coated with the present composition was then placed in an oven set at a temperature of 305° C. and maintained in the oven for about 35 seconds, at which point the metal temperature reached about 232° C. The sample was removed from the oven and then quenched in water and dried with a tissue. The dry thickness of the varnish was about 5 um. Properties were tested as per Examples 5, 6 and 7, and the results are reported in Table 6B below, together with testing using the same procedures for two other varnish materials:

TABLE 6B

| | | | | Results | |
|---|---|---|---|---|---|
| | | | Exam- | Compet- | Zendura |
| Property | Test Method | | ple H | itor | C100 |
| Gloss | ASTM D 523 | 60° | 81.7 | 75.2 | 82.1 |
| Color change | Against white | | 0.82 | 1.38 | 1.97 |
| | PVDF | | | | |
| Pencil | ASTM D 3363 | Gouge | 2H | 2H | 2H |
| hardness | | | | | |
| Flexibility | ASTM D 4145 | T-bend | 0T | 1T | 0T |
| Dry adhesion | ASTM D 3359 | Cross- | 5B | 5B | 5B |
| | | hatch | | | |
| Wet adhesion | AAMA 2605 | 8.4.1.3 | 5B | 5B | 5B |
| | | 8.4.1.4 | 5B | 4B | 4B |

| | | | |
|---|---|---|---|
| Acid resistance | AAMA 2605 | 8.7.1 | No blistering, |
| | | | no color change |

The gloss retention results show that gloss retention is initially about 100% and remains at or very near 100% for about 3250 hours of the test. This result is illustrated in FIG. 2 hereof, which also shows for comparison materials a dramatic an step drop-off in performance at about 1000 hours and about 2500 hours.

1. A fluorocopolymer formed by copolymerization of:
(1) haloolefin monomers consisting essentially of:
(a) hydrofluorolefin selected from the group consisting of hydro fluoroethy1enes, hydrofluoropropenes, hydrofluorobutenes, hydrofluoropentenes and combinations of these, and
(b) one or more chlorofluoroethylene monomers wherein the mole ratio of said hydrofluoroolefin monomer to said chlorofluoroethylene monomers monomer is from about 0.5:1 to about 1.5:1; and
(2) alkyl vinyl ether monomer(s) and/or alkyl vinyl ester monomers consisting essentially of:
(a) one or more lower alkyl vinyl ether monomers that are not substituted with a reactive group; and
(b) one or more reactive group substituted lower alkyl vinyl ether monomer(s) and/or one or more reactive group substituted, lower alkyl vinyl ester monomer(s), wherein the mole ratio of (2)(a) monomers to said (2)(b) monomers is from about 2:1 to about 6:1, and
(3) optionally one or more alkyl vinyl ester monomers that do not contain a reactive group substituted thereon, wherein the mole ratio of said haloolefin monomers to said alkyl vinyl ether monomer(s) is from about 0.5:1 to about 1.5:1.

2. The fluorocopolymer of claim 1 wherein said hydrofluorolefin comprises hydrofluoropropenes.

3. The fluorocopolymer of claim 1 wherein said hydrofluorolefin consists consists essentially of hydrofluoropropenes.

4. The fluorocopolymer of claim 3 wherein said hydrofluoropropenes are selected from 2,3,3,3-tetrafluoropropene, 1,3,3,3-tetrafluoropropene, and combinations of these.

5. The fluorocopolymer of claim 1 wherein said hydrofluorolefin consists essentially of 1,3,3,3-tetrafluoropropene.

6. The fluorocopolymer of claim 1 wherein said hydrofluorolefin consists essentially of trans-1,3,3,3-tetrafluoropropene.

7. The fluorocopolymer of claim 1 wherein said one or more chlorofluoroethylene monomers comprises chlorotrifluoroethylene (“CTFE”) monomers.

8. The fluorocopolymer of claim 1 wherein said one or more reactive group substituted lower alkyl vinyl ether monomer(s) and/or one or more reactive group substituted, lower alkyl vinyl ester monomer(s) comprises a hydroxyl substituted lower alkyl vinyl ether monomer.

9. The fluorocopolymer of claim 1 having a number average molecular weight of from about 33,000 to about 38,000.

10. The fluorocopolymer of claim 1 having a hydroxyl value of from about 75 to about 100.
